(19) United States
(12) Patent Application Publication
(10) Pub. No.: US 2022/0149437 A1
(43) Pub. Date: May 12, 2022

(54) LITHIUM-ION BATTERY, AND RELATED BATTERY MODULE, BATTERY PACK, AND APPARATUS

(71) Applicant: CONTEMPORARY AMPEREX TECHNOLOGY CO., LIMITED, Ningde City (CN)

(72) Inventors: Chengdu LIANG, Ningde City (CN); Zhiqiang LI, Ningde City (CN); Changlong HAN, Ningde City (CN)

(73) Assignee: CONTEMPORARY AMPEREX TECHNOLOGY CO., LIMITED, Ningde City (CN)

(21) Appl. No.: 17/583,728

(22) Filed: Jan. 25, 2022

Related U.S. Application Data
(63) Continuation of application No. PCT/CN2020/100291, filed on Jul. 16, 2020.

(30) Foreign Application Priority Data
Jul. 30, 2019 (CN) 201910695499.5

(51) Int. Cl. H01M 10/0568; H01M 10/0525; H01M 4/587; H01M 4/36; H01M 10/0569; C01D 15/00; C01B 21/086

(52) U.S. Cl. CPC H01M 10/0568; H01M 10/0525; H01M 4/587; H01M 2004/027; H01M 10/0569; C01D 15/005; C01B 21/086; H01M 4/364

(57) ABSTRACT

This application discloses a lithium-ion battery, and related battery module, a battery pack, and an apparatus. The lithium-ion battery includes a positive electrode plate, a negative electrode plate, a separator, and an electrolyte, where the negative electrode plate includes a negative electrode active material layer containing a negative electrode active material, and the electrolyte includes an electrolyte lithium salt. The electrolyte lithium salt includes a first lithium salt, the first lithium salt is selected from fluorine-containing sulfonimide lithium salts, and the first lithium salt and the negative electrode plate satisfy the following relation (1). The lithium-ion battery of this application has high safety performance, long cycle life, and good high-temperature storage performance.

$$0.6 \leq \frac{{M}_{E} \times {C}_{I}}{\frac{{M}_{A}}{P {D}_{A}} \times {P}_{A}} \leq 6.2 \qquad ( 1 )$$

This application is a continuation of International Patent Application No. PCT/CN2020/100291 filed on Jul. 16, 2020, which claims priority to Chinese Patent Application No. CN201910695499.5 filed on Jul. 30, 2019 which are incorporated herein by reference in its entirety.

### TECHNICAL FIELD

This application relates to the field of battery technologies, and in particular, to a lithium-ion battery, and related battery module, battery pack, and apparatus.

### BACKGROUND

Since the mass production of lithium-ion batteries at the end of the 20^{th} century, lithium-ion batteries have been widely used in the field of consumer electronics due to their advantages such as high specific energy, no memory effect, and long cycle life. In recent years, the situation of global environmental protection has become increasingly severe, and shortage of fossil fuels has become more serious. Therefore, with the continuous development of materials and processes, lithium-ion batteries, as a clean energy source, have gradually become an important source of power for automobiles.

Most of commonly used traction batteries use lithium iron phosphate or lithium nickel manganese cobalt oxide ternary material as positive electrode active materials. Lithium iron phosphate with stable structure and low activity can provide high safety and long cycle life, but its energy density is often unable to meet the requirement for an increasing driving range of electric cars because of low plateau and specific energy. The lithium nickel manganese cobalt oxide ternary material combines advantages of lithium nickelate, lithium cobalt oxide, and lithium manganate, with obvious advantages in life and energy density. However, the ternary material is not structurally stable enough, and is alkaline. Consequently, in an electrolyte with lithium hexafluorophosphate as the main salt, its safety performance is difficult to guarantee due to the influence of trace HF therein, and thermal runaway is very easy to occur during thermal shock. Compared with lithium hexafluorophosphate, lithium bis(fluorosulfonyl)imide (LiFSI) has a lower F element content and better thermal stability, and can provide excellent battery safety. However, excessive LiFSI content can easily cause the battery's high voltage resistance performance to deteriorate.

### SUMMARY

In view of the disadvantages in the prior art, an objective of this application is to provide a lithium-ion battery with high voltage resistance performance to resolve the prior-art problem.

In order to achieve the above and other related objectives, according to a first aspect, this application provides a lithium-ion battery, including a positive electrode plate, a negative electrode plate, a separator, and an electrolyte, where the negative electrode plate includes a negative electrode active material layer containing a negative electrode active material, and the electrolyte includes an electrolyte lithium salt. The electrolyte lithium salt includes a first lithium salt, where the first lithium salt is selected from fluorine-containing sulfonimide lithium salts, and the first lithium salt and the negative electrode plate satisfy the following relation (1):

$$0.6 \leq \frac{{M}_{E} \times {C}_{I}}{\frac{{M}_{A}}{P {D}_{A}} \times {P}_{A}} \leq 6.2 \qquad ( 1 )$$

where M_{E} is a total mass of the electrolyte in the lithium-ion battery, measured in g;

C_{I} is a mass percentage of the first lithium salt with respect to the electrolyte, measured in %;

M_{A} is a total mass of the negative electrode active material layer in the lithium-ion battery, measured in g;

PD_{A} is a compacted density of the negative electrode active material layer, measured in g/cm³; and

P_{A} is a porosity of the negative electrode active material layer, measured in %.

According to a second aspect, this application provides a battery module, including the lithium-ion battery according to the first aspect of this application.

According to a third aspect of this application, this application provides a battery pack, including the battery module according to the second aspect of this application.

According to a fourth aspect of this application, this application further provides an apparatus, including the lithium-ion battery according to the first aspect of this application.

Compared with the prior art, this application has the following beneficial effects:

In this application, the electrolyte in which a fluorine-containing sulfonimide lithium salt is used as the first lithium salt is used, and the amount of fluorine-containing sulfonimide lithium salt that can be accommodated per unit volume of pores in the negative electrode plate is controlled to be in a specific range, which can effectively prevent the battery impedance from increasing too fast or the concentration polarization from becoming too large, and take full advantage of high temperature resistance and high electrical conductivity of the fluorine-containing sulfonamide lithium salt. The battery thus prepared has a relatively low increase rate of physical resistance in floating charge, so that safety problems such as lithium plating generated in the mid-late stage of cycling can be avoided, and the battery finally achieves high safety performance, long cycle life, and good high-temperature storage performance.

### BRIEF DESCRIPTION OF DRAWINGS

FIG. 1 is a schematic diagram of an embodiment of a lithium-ion battery according to this application.

FIG. 2 is an exploded schematic diagram of an embodiment of a lithium-ion battery according to this application.

FIG. 3 is a schematic diagram of an embodiment of a battery module.

FIG. 4 is a schematic diagram of an embodiment of a battery pack.

FIG. 5 is an exploded diagram of FIG. 4.

FIG. 6 is a schematic diagram of an embodiment of an apparatus using a lithium-ion battery as a power supply according to this application.

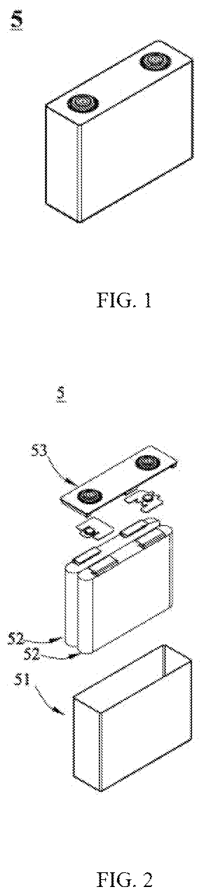

Reference signs are described as follows:

1. battery pack

2. upper box body

3. lower box body

4. battery module

5. lithium-ion battery

51. housing

52. electrode assembly

53. cover plate.

### DESCRIPTION OF EMBODIMENTS

To make the objectives, technical solutions, and advantages of this application more comprehensible, the following describes this application in detail with reference to embodiments and accompanying drawings. It should be understood that the specific embodiments described herein are merely used to explain this application but are not intended to limit this application.

For brevity, this specification specifically discloses only some numerical ranges. However, any lower limit may be combined with any upper limit to form an unspecified range, and any lower limit may be combined with another lower limit to form an unspecified range, and likewise, any upper limit may be combined with any other upper limit to form an unspecified range. In addition, each individually disclosed point or single numerical value, as a lower limit or an upper limit, may be combined with any other point or single numerical value or combined with another lower limit or upper limit to form an unspecified range.

In the descriptions of this specification, it should be noted that “more than” or “less than” is inclusive of the present number and that “more” in “one or more” means two or more than two, unless otherwise specified.

Unless otherwise specified, terms used in this application have well-known meanings generally understood by persons skilled in the art. Unless otherwise specified, numerical values of parameters mentioned in this application may be measured by using various measurement methods commonly used in the art (for example, testing may be performed by using a method provided in the embodiments of this application).

### Lithium-Ion Battery

The following describes in detail the lithium-ion battery according to this application.

A first aspect of this application provides a lithium-ion battery (also known as a lithium-ion secondary battery), including a positive electrode plate, a negative electrode plate, a separator, and an electrolyte, where the negative electrode plate includes a negative electrode active material layer containing a negative electrode active material, and the electrolyte includes an electrolyte lithium salt. The electrolyte lithium salt includes a first lithium salt, where the first lithium salt is selected from fluorine-containing sulfonimide lithium salts, and the first lithium salt and the negative electrode plate satisfy the following relation (1):

$$0.6 \leq \frac{{M}_{E} \times {C}_{I}}{\frac{{M}_{A}}{P {D}_{A}} \times {P}_{A}} \leq 6.2 \qquad ( 1 )$$

where M_{E} is a total mass of the electrolyte in the lithium-ion battery, measured in g; C_{I} is a mass percentage of the first lithium salt with respect to the electrolyte, measured in %; M_{A} is a total mass of the negative electrode active material layer in the lithium-ion battery, measured in g; PD_{A} is a compacted density of the negative electrode active material layer, measured in g/cm³; and P_{A} is a porosity of the negative electrode active material layer, measured in %.

In this application, to solve the safety risks that trace HF in the electrolyte may bring to ternary materials, a lithium salt containing a relatively low percentage of F element serves as a main salt of the electrolyte. Fluorine-containing sulfonimide lithium salts contain a relatively low percentage of F element, have good thermal stability, and generate less HF, thereby effectively suppressing gas production of positive electrode materials, and providing excellent battery safety. In addition, an electrolyteformulated from a fluorine-containing sulfonimide lithium salt has higher electrical conductivity than a lithium hexafluorophosphate electrolyte, and shows obvious advantages in both cycling and storage life.

In the lithium-ion battery provided in this application, a too high concentration of the fluorine-containing sulfonimide lithium salt in the electrolyte may cause higher viscosity and poorer fluidity of the electrolyte, which affects wide application of the material in lithium-ion batteries. Therefore, in this application, based on micro-structural features of the negative electrode plate, the amount of fluorine-containing sulfonimide lithium salt that can be accommodated per unit volume of pores in the negative electrode active material layer is adjusted to be in a specific range, and fluidity of the fluorine-containing sulfonimide lithium salt in the negative electrode active material layer is controlled by adjusting the liquid retention capacity of the negative electrode active material layer, thereby effectively suppressing rapid consumption of the quite safe electrolyte, preventing the battery impedance from increasing too fast or the concentration polarization from becoming too large, and avoiding safety problems such as lithium plating generated in the mid-late stage of cycling.

In some embodiments of this application, the fluorine-containing sulfonimide lithium salt contained per unit volume of pores in the negative electrode active material layer may be 0.6 g/cm³ to 6.2 g/cm³, 0.6 g/cm³ to 1.0 g/cm³, 1.0 g/cm³ to 1.5 g/cm³, 1.5 g/cm³ to 2.0 g/cm³, 2.0 g/cm³ to 2.5 g/cm³, 2.5 g/cm³ to 3.0 g/cm³, 3.0 g/cm³ to 3.5 g/cm³, 3.5 g/cm³ to 4.0 g/cm³, 4.0 g/cm³ to 4.5 g/cm³, 4.5 g/cm³ to 5.0 g/cm³, 5.0 g/cm³ to 5.5 g/cm³, 5.5 g/cm³ to 6.0 g/cm³, or 6.0 g/cm³ to 6.2 g/cm³.

In the lithium-ion battery provided in this application, the fluorine-containing sulfonimide lithium salt is a lithium salt with a chemical structure formula shown in Formula I:

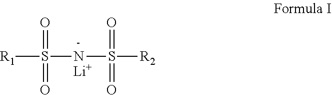

where R₁ and R₂ each may be independently selected from a fluorine atom or a fluorinated hydrocarbyl group having 1 to 8 carbon atoms, and at least one of R₁ and R₂ includes fluorine. Preferably, R₁ and R₂ each may be independently selected from —CₐH_{b}F_{c} or —CF₂CF₂(OCF₂CF₂)_{d}F, where a is 0, 1, 2, 3, 4, 5, 6, 7 or 8, b and c are integers, b+c=2a+1, and d is 1, 2 or 3. More preferably, a is 0, 1, 2, 3 or 4. For example, R₁ and R₂ each may be independently selected from a fluorine atom, —CH₃, —CHF₂, —CH₂F, —CF₃, —C₂F₅, —C₃F₇, —C₄F₉, or —CF₂CF₂OCF₂CF₃.

In some preferable embodiments of this application, the fluorine-containing sulfonimide lithium salt may be selected from one or more of lithium bis(fluorosulfonyl)imide (LiFSI), lithium fluorosulfonyl (trifluoromethanesulfon)imide, lithium bistrifluoromethanesulfonimide (LiTFSI), lithium methyl trifluoromethanesulfonimide, lithium fluoromethyl (pentafluoroethyl) sulfonimide, and lithium bis(pentafluoroethyl)sulfonimide. Most preferably, the fluorine-containing sulfonimide lithium salt may include lithium bis(fluorosulfonyl)imide, or the fluorine-containing sulfonimide lithium salt may be selected from lithium bis(fluorosulfonyl)imide.

In the lithium-ion battery provided in this application, with respect to the total mass C_{I} of the electrolyte, the mass percentage of the first lithium salt (that is, the fluorine-containing sulfonimide lithium salt, LiFSI) may be 4.0 wt % or above, preferably, may be 5.0 wt % or above, or more preferably, may be 5.5 wt % or above. In this application, due to structural characteristics of the fluorine-containing sulfonimide lithium salt itself, the fluorine-containing sulfonimide lithium salt has high electrical conductivity at normal temperature, and more stable than the conventional lithium salt (LiPF₆), and less sensitive to water and temperature. Therefore, the fluorine-containing sulfonimide lithium salt in this application has high chemical stability and electrochemical stability, and may be used to improve the stability and power performance of the electrolyte. In this application, the relative percentage of the fluorine-containing sulfonimide lithium salt contained in the electrolyte falling within the foregoing ranges may prevent viscosity of the electrolyte from increasing too high while efficiently improving ionic conductivity performance of the electrolyte.

In the lithium-ion battery provided in this application, the electrolyte lithium salt may further include a second lithium salt. The second lithium salt may be selected from one or more of inorganic lithium salts and organic lithium salts. In some embodiments of this application, the second lithium salt may be selected from one or more of LiPF₆, LiBF₄, LiSbF₆, LiAsF₆, LiClO₄, and LiB(C₂O₄)₂, more preferably, the second lithium salt may be selected from one or more of LiPF₆, LiBF₄, LiPO₂F₂, and Li₃POF, or in particular preferably, the second lithium salt may include LiPF₆, or the second lithium salt may be selected from LiPF₆.

The applicants have discovered through research that when an inorganic fluorine-containing lithium salts used as the second lithium salt is firstly charged, a part of the lithium salt is decomposed to produce fluorine ions, and the fluorine ions react with aluminum foil to form an aluminum fluoride passivation layer, suppressing corrosion of the aluminum foil. It has been found through research that when the amount of an inorganic fluorine-containing lithium salt contained in total lithium salts is greater than 10 mol % (molar ratio), corrosion of aluminum foil can be effectively suppressed. However, when the inorganic fluorine-containing lithium salt is used as the main lithium salt, or its content is too high, the film-forming effect at the cathode is not good, thereby deteriorating the gas production problem during high-temperature storage. Therefore, when the fluorine-containing sulfonimide lithium salt serves as the first lithium salt, and the inorganic fluorine-containing lithium salt serves as the second lithium salt, balance can be struck between electrical conductivity of the electrolyte and corrosion of the aluminum foil. In some embodiments of this application, a molar ratio of the first lithium salt to the second lithium salt may range from 1:1 to 20:1, more preferably, may range from 1.2:1 to 10:1, or in particular preferably, may range from 6:4 to 9:1. For example, the molar ratio of the first lithium salt to the second lithium salt may range from 2:1 to 7:3, from 7:3 to 3:1, from 3:1 to 4:1, from 4:1 to 5:1, from 5:1 to 6:1, from 6:1 to 7:1, or from 7:1 to 8:1.

In some preferable embodiments of this application, a total concentration of the lithium salts in the electrolyte may range from 0.5 mol/L to 2.0 mol/L, from 0.5 mol/L to 0.6 mol/L, from 0.6 mol/L to 0.7 mol/L, from 0.7 mol/L to 0.8 mol/L, from 0.8 mol/L to 0.9 mol/L, from 0.9 mol/L to 1.0 mol/L, from 1.0 mol/L to 1.1 mol/L, from 1.1 mol/L to 1.2 mol/L, from 1.2 mol/L to 1.3 mol/L, from 1.3 mol/L to 1.4 mol/L, from 1.4 mol/L to 1.5 mol/L, from 1.5 mol/L to 1.6 mol/L, from 1.6 mol/L to 1.7 mol/L, from 1.7 mol/L to 1.8 mol/L, from 1.8 mol/L to 1.9 mol/L, or from 1.9 mol/L to 2.0 mol/L, and further preferably may range from 0.6 mol/L to 1.8 mol/L, from 0.7 mol/L to 1.7 mol/L, or from 0.8 mol/L to 1.5 mol/L.

In the lithium-ion battery provided in this application, the electrolyte may further include an additive. Oxidation potential of the additive included in the electrolyte may be suitable for forming a relatively stable passivation film on a positive electrode surface, and while the passivation film is formed, under the driving of the potential, a dense protective film can be formed on the aluminum foil, which improves corrosion resistance of the aluminum foil, and helps to improve safety performance and long-term cycling performance of the lithium-ion battery. In some embodiments of this application, the additive may be selected from one or more of fluoroethylene carbonate, lithium difluorophosphate, lithium difluoroacetate borate, or lithium difluorobisoxalate phosphate.

In the lithium-ion battery provided in this application, the electrolyte may include an organic solvent. The organic solvent is usually used as a solvent to form an electrolyte system. The organic solvent included in the electrolyte may be various organic solvents suitable for an electrolyte of a lithium-ion battery in the art. For example, the organic solvent may be one or more of dimethyl carbonate (DMC), diethyl carbonate (DEC), dipropyl carbonate (DPC), ethyl methyl carbonate (EMC), methyl propyl carbonate (MPC), ethylene propyl carbonate (EPC), vinyl ethylene carbonate (VEC), ethylene carbonate (EC), propylene carbonate (PC), γ-butyrolactone (GBL), butylene carbonate (BC), fluoroethylene carbonate (FEC), methylmethyl formate (MF), ethyl formate, methyl acetate (MA), ethyl acetate (EA), propyl acetate (PA), methyl propionate (MP), ethyl propionate (EP), propyl propionate (PP), methyl butyrate (MB), ethyl butyrate (EB), sulfolane (SF), methyl sulfonyl methane (MSM), methyl ethyl sulfone (EMS), diethyl sulfone (ESE), tetrahydrofuran (THF), and propylene sulfite. In some preferable embodiments of this application, when the non-aqueous organic solvent includes a cyclic carbonate (cyclic carbonate), the percentage of the cyclic carbonate contained is not greater than 10 wt %. The cyclic carbonate may include five-membered, six-membered, seven-membered cyclic carbonates, and macrocyclic carbonates with more than seven members, and specifically may be one or more of vinyl ethylene carbonate (VEC), ethylene carbonate (EC), propylene carbonate (PC), butylene carbonate (BC), and fluoroethylene carbonate (FEC). This is because when a high concentration of a fluorine-containing sulfonimide lithium salt is included in the electrolyte, if the organic solvent is a cyclic carbonate, too many of cyclic carbonates may cause side reactions of the electrolyte at the cathode to increase and an obvious increase of gas production, leading to the safety problem and the gas production problem during cycling of the lithium-ion battery.

In the lithium-ion battery provided in this application, the negative electrode plate usually includes a negative current collector and a negative electrode active material layer on a surface of the negative current collector, and the negative electrode active material layer usually includes a negative electrode active material. The negative electrode active material may be various negative electrode active materials suitable for lithium-ion batteries in the art. For example, the negative electrode active material may include one or more of artificial graphite and natural graphite. Preferably, the negative electrode active material may further include one or more of a mesocarbon microbead (MCMB), hard carbon, soft carbon, silicon, a silicon-carbon composite, SiO, a Li-Sn alloy, a Li—Sn—O alloy, Sn, SnO, SnO₂, spinel-structure lithium titanate LiₐTi₅O₁₂, a Li—Al alloy, and metal lithium. The negative current collector may be a material such as a metal foil material or a porous metal plate. For example, metal suitable for the negative current collector may be copper, nickel, titanium, iron, and other metals, or their alloys.

In the lithium-ion battery provided in this application, the negative electrode active material layer may further include an electrically conductive agent, a binder, a thickener, and the like. If necessary, a solvent or other additives may also be included in the negative electrode plate. The electrically conductive agent, the binder, and the thickener in the negative electrode active material layer may be various materials suitable for lithium-ion batteries, and may be selected by persons skilled in the art according to an actual need. For example, the electrically conductive agent may be one or more of graphite, superconducting carbon, acetylene black, carbon black, Ketjen black, a carbon dot, a carbon nanotube, graphene, and carbon nanofiber; for another example, the binder may be one or more of styrene butadiene rubber (SBR), polyvinylidene fluoride (PVDF), polytetrafluoroethylene (PTFE), polyvinyl butyral (PVB), water-based acrylic resin (water-based acrylic resin), and carboxymethyl cellulose (CMC); and for a further example, the thickener may be carboxymethyl cellulose (CMC) or the like.

In the lithium-ion battery provided in this application, the compacted density and the porosity of the negative electrode active material layer usually are required to be within appropriate ranges, thereby ensuring the lithium-ion battery has a relatively high volume energy density, and that the amount of compression deformation on particles of the negative electrode active material is relatively low. This is beneficial to rapid infiltration of the electrolyte into pores in the negative electrode plate. In some preferable embodiments of this application, the compacted density PD_{A} of the negative electrode active material layer may range from 1.5 g/cm³ to 2.1 g/cm³, from 1.5 g/cm³ to 1.6 g/cm³, from 1.6 g/cm³ to 1.65 g/cm³, from 1.65 g/cm³ to 1.7 g/cm³, from 1.7 g/cm³ to 1.8 g/cm³, from 1.8 g/cm³ to 1.9 g/cm³, from 1.9 g/cm³ to 2.0 g/cm³, or from 2.0 g/cm³ to 2.1 g/cm³, or preferably, from 1.5 g/cm³ to 1.65 g/cm³. In other preferable embodiments of this application, the porosity of the negative electrode plate may range from 10% to 50%, from 10% to 15%, from 15% to 18%, from 18% to 20%, from 20% to 24%, from 24% to 26%, from 26% to 30%, from 30% to 34%, from 34% to 37%, from 37% to 38%, from 38% to 42%, from 42% to 46%, or from 46% to 50%, or more preferably, from 15% to 37%.

After a lithium-ion battery is fully charged, theoretically, the charging process is terminated, but in reality, battery voltage gradually decreases due to internal self-discharge of the battery. Floating charge is to continuously charge the lithium-ion battery with a small current to keep the battery fully charged. When the lithium-ion battery is continuously subjected to floating charge for a long time, the battery is in a highly charged state for a long time. In this case, the electrolyte is more likely to decompose, and a rate at which anions of the fluorine-containing sulfonimide salt corrode the positive current collector also increases under a high voltage, thereby increasing the resistance of the lithium-ion battery and reducing long-term cycling performance and safety performance of the battery.

In the lithium-ion battery provided in this application, an increase rate AR of physical resistance in floating charge reflects a change rate of the physical resistance of the lithium-ion battery before and after floating charge. Specifically, the rate can be calculated by the following method: ΔR=(R2−R1)/R1, where R1 is physical resistance of the lithium-ion battery at 1 kHz, and R2 is physical resistance of the lithium-ion battery at 1 kHz after the lithium-ion battery is charged at a constant current of 1 C to a rated voltage, constant-voltage charged at the rated voltage until the current is 0.1 C, and constant-voltage charged at the rated voltage for 24 hours. In a preferable embodiment of this application, the upper limit of the increase rate ΔR of physical resistance in floating charge does not exceed 55, more preferably, not exceed 50, and most preferably, not exceed 30.

In the lithium-ion battery provided in this application, the positive electrode plate usually includes a positive current collector and a positive electrode active material layer on a surface of the positive current collector, and the positive electrode active material layer usually includes a positive electrode active material. The positive electrode active material may be selected from various positive electrode active materials suitable for the secondary battery in the art. For example, the positive electrode active material may include but is not limited to a lithium transition metal composite oxide. More specifically, the lithium transition metal composite oxide may include but is not limited to one or more of a lithium iron phosphide, a lithium iron manganese phosphide, a lithium cobalt oxide, a lithium nickel oxide, a lithium manganese oxide, a lithium nickel manganese oxide, a lithium nickel cobalt manganese oxide, a lithium nickel cobalt aluminum oxide, or a compound obtained by adding other transition metal or non-transition metal to these lithium transition metal oxides. The positive current collector may be a material such as a metal foil material or a porous metal plate. For example, a metal suitable for the positive current collector may be copper, aluminum, and other metals, or their alloys.

In the lithium-ion battery provided in this application, usually a separator is also included. The separator may be of various materials suitable for a separator of a lithium-ion battery in the art, and for example, may include but is not limited to one or more of polyethylene, polypropylene, polyvinylidene fluoride, aramid, polyethylene terephthalate, polytetrafluoroethylene, polyacrylonitrile, polyimide, polyamide, polyester, and a natural fiber.

In the lithium-ion battery provided in this application, the positive electrode plate, the separator, and the negative electrode plate generally may be used to form a battery core of the lithium-ion battery. For example, each of the positive electrode plate, the separator, and the negative electrode plate may be a layer, so may be cut to a target size and then stacked in order, and may be further combined with an electrolyte to form a lithium-ion battery. The positive electrode plate, the separator, and the negative electrode plate may be directly formed as a single-layer laminated battery, and may be further wound to a target size, so as to form a battery core and further form a lithium-ion battery by combining with an electrolyte. However, in a preferable embodiment of this application, the lithium-ion battery is a single-layer laminated battery. Such a battery is easier to operate in a floating charge process, and has lower screening costs. The lithium-ion battery may further include other various components that may be used for a lithium-ion battery. For example, the suitable components may include but are not limited to a packaging case, a tab, an external electrode, and the like.

### Battery Module

Next, a battery module according to the second aspect of the present invention is briefly described.

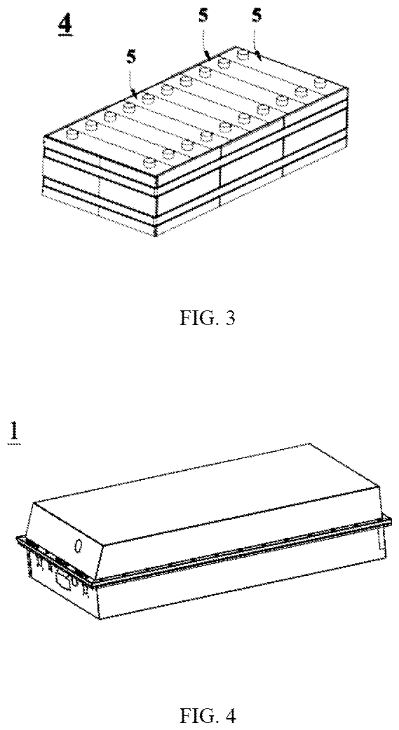

FIG. 3 shows a three-dimensional diagram of a battery module according to an embodiment of the present invention. Referring to FIG. 3, the battery module 4 according to the present invention includes a plurality of battery cells 5, and the plurality of battery cells 5 are arranged along a longitudinal direction.

The battery module 4 may be used as a power supply or an energy storage apparatus. A quantity of the battery cells 5 included in the battery module 4 may be adjusted based on use and capacity of the battery module 4.

### Battery Pack

Next, a battery pack according to the third aspect of this application is briefly described.

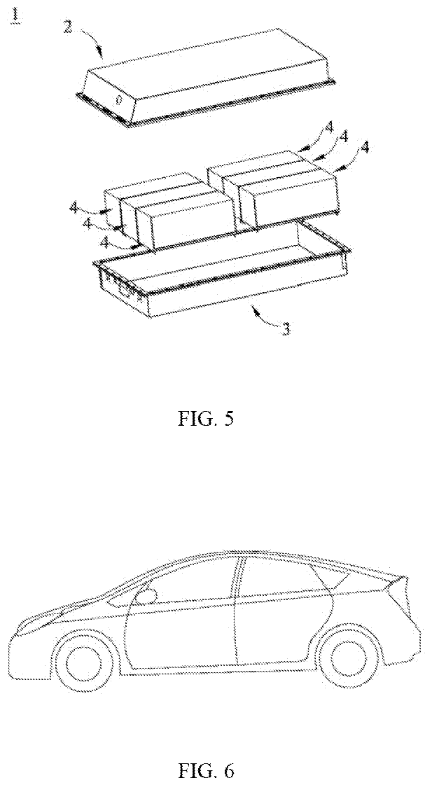

FIG. 4 shows a three-dimensional diagram of a battery pack according to an embodiment of this application, and FIG. 5 is an exploded diagram of the battery pack shown in FIG. 4.

Referring to FIG. 4 and FIG. 5, the battery pack 1 according to this application includes an upper box body 2, a lower box body 3, and the battery module 4. The upper box body 2 and the lower box body 3 are assembled together to form a space for accommodating the battery module 4. The battery module 4 is disposed in the space formed by the upper box body 2 and the lower box body 3 that are assembled together.

An output electrode of the battery module 4 extends from one or both of the upper box body 2 and the lower box body 3 to supply power to an outside or be charged from the outside.

It should be noted that the quantity and arrangement of the battery modules 4 used in the battery pack 1 may be determined based on an actual need. The battery pack 1 may be used as a power supply or an energy storage apparatus.

### Apparatus

Next, an apparatus according to a fourth aspect of this application is briefly described. The apparatus includes the lithium-ion battery according to the first aspect of this application. The lithium-ion battery may be used as a power supply for the apparatus, or an energy storage unit of the apparatus. The apparatus may be, but is not limited to, a mobile device (for example, a mobile phone or a notebook computer), an electric vehicle (for example, a battery electric vehicle, a hybrid electric vehicle, a plug-in hybrid electric vehicle, an electric bicycle, an electric scooter, an electric golf vehicle, or an electric truck), an electric train, a ship, a satellite, an energy storage system, and the like.

The apparatus of this application uses the lithium-ion battery provided in this application, and therefore has at least the same advantages as the lithium-ion battery.

FIG. 6 shows a schematic diagram of an apparatus using a lithium-ion battery as a power supply according to an embodiment of this application. Just as an example, in FIG. 6, the apparatus that uses battery cells 5 is an electric car. The apparatus that uses battery cells 5 may be any electric vehicles other than electric cars (for example, an electric bus, a tramcar, an electric bicycle, an electric motorbike, an electric scooter, an electric golf cart, and an electric truck), an electric vessel, an electric tool, an electronic device, and an energy storage system.

A lithium-ion battery, a battery module, or a battery pack may be selected for the apparatus according to requirements for using the apparatus.

In another example, the apparatus may be a mobile phone, a tablet computer, a notebook computer, or the like. The apparatus is generally required to be light and thin, and may use a lithium-ion battery as its power supply.

The following describes implementations of this application by using specific examples. Persons skilled in the art can easily learn other advantages and effects of this application through content disclosed in this specification. This application may also be implemented or applied through other different specific implementations, and various modifications or changes may also be made to each of the details in the specification based on different perspectives and applications without departing from the spirit of this application.

It should be noted that process devices or apparatuses not specifically noted in the following examples all adopt conventional devices or apparatuses in the art.

In addition, it should be understood that the one or more method steps mentioned in this application do not exclude that there may be other method steps before and after the combined steps or that other method steps may be inserted between these explicitly mentioned steps, unless otherwise specified. It should further be understood that the combination and connection relationship between one or more devices/apparatuses mentioned in this application do not exclude that there may be other devices/apparatuses before and after the combined devices/apparatuses or that other devices/apparatuses may be inserted between the two explicitly mentioned devices/apparatuses, unless otherwise specified. Moreover, unless otherwise specified, numbers of the method steps are merely a tool for identifying the method steps, but are not intended to limit the order of the method steps or to limit the implementable scope of the present invention. Alteration or adjustment of their relative relationships without substantial changes in the technical content shall be also considered as the implementable scope of this disclosure.

### EXAMPLE 1

Preparation of a positive electrode plate:

LiNi_{0.8}Co_{0.1}Mn_{0.1}O₂ as a positive electrode active material, conductive carbon black SP, and a binder PVDF were dispersed into the solvent NMP and well mixed to obtain a positive electrode slurry. The positive electrode slurry was uniformly applied onto a positive current collector aluminum foil, with a coating weight of the positive electrode slurry of 0.309 g/1540.25 mm² (calculated by weight without the solvent). The aluminum foil was dried, cold pressed, slitting, and cut to obtain a positive electrode plate, where a mass ratio of the positive electrode active material to conductive carbon black to the binder PVDF is 96:2:2.

Preparation of a negative electrode plate:

Natural graphite as a negative electrode active material, conductive carbon black SP, a thickener CMC, and a binder SBR were dispersed into the deionized water solvent at a mass ratio of 96:1:1:2 and well mixed to obtain a negative electrode slimy. The negative electrode slurry was uniformly applied onto a negative current collector copper foil which was then dried, cold pressed, slit, and cut. With adjustment, the cold pressing pressure was 120 to 250 tons, a coating weight of the negative electrode slurry was 0.15 g/1540.25 mm² (calculated by weight without the solvent), and a particle size Dv50 of the negative electrode active material particles was 14 μm, so a negative electrode plate with a compacted density of 1.5 g/cm³ and a porosity of 30% was obtained. The compacted density of the negative electrode plate can be calculated according to the formula P=m/v (m is the weight of the negative electrode active material layer, measured in g; and v is the volume of the negative electrode active material layer, measured in cm³, and v can be a product of the area and the thickness of the negative electrode active material layer). A true density tester AccuPyc II 1340 can be used to test the porosity of the negative electrode plate by following the instrument manual.

Preparation of an electrolyte:

In a glove box full of argon gas (water content <10 ppm, oxygen content <1 ppm), a first lithium salt LiFSI and a second lithium salt LiPF₆ were added at a specific molar ratio (the sum of lithium salt concentrations was 1 M) into a non-aqueous organic solvent which was ethylene carbonate or ethyl methyl carbonate, and the percentage of cyclic carbonate (ethylene carbonate) contained was 20 wt %. After the lithium salt was completely dissolved, an appropriate amount of other additives was added and stirred evenly, and an electrolyte with a lithium salt concentration of 1.0 mol/L was obtained.

Preparation of a separator:

A 16-micron polyethylene film (PE) was used as a separator.

Preparation of a lithium-ion battery:

The prepared positive electrode plate, separator, and negative electrode plate were stacked in order, so that the separator was placed between the positive and negative electrode plates to play a role of separating the positive electrode plate from the negative electrode plate, and winding was performed to obtain a bare battery core. After tabs were welded, the bare battery core was placed in an outer package, and the foregoing prepared electrolyte was injected into the dried battery core. The preparation of the lithium-ion battery was completed after packaging, standing, chemical conversion, shaping, capacity test, and the like were performed. The soft-packaged lithium-ion battery was 4.0 mm in thickness, 60 mm in width, and 140 mm in length. In the foregoing soft-packaged lithium-ion battery, a total mass of the negative electrode active material layer was 25 g, and a total mass of the electrolyte was 14 g.

### EXAMPLES 2 TO 10 AND COMPARATIVE EXAMPLES 1 TO 3

Preparation methods of the positive electrode plates, the negative electrode plates, the electrolytes and the lithium-ion batteries in Examples 2 to 10 and Comparative Examples 1 to 3 were basically the same as those in Example 1, except that a coating weight of the negative electrode slurry, an average particle size of the negative electrode active materials, and manufacturing parameters such as cold pressing pressure were changed, and a total mass M_{A} and a compacted density PD_{A} of the negative electrode active material, and a porosity P_{A} of an electrode plate were adjusted. Formulas and physical parameters of the examples and comparative examples were shown in Table 1.

TABLE 1

| | Electrolyte | | | | | | | Negative electrode | | | |
|---|---|---|---|---|---|---|---|---|---|---|---|
| | | Mass | | Mass | | | | Total | | | |
| | | ratio of | | ratio of | | | | mass M_{A} | | | Formula 1 |
| No. | First lithium salt material | first lithium salt (wt %) | Second lithium salt material | second lithium salt (wt %) | Total mass M_{E} of electrolyte (g) | Percentage of cyclic carbonate contained | Combination of additives | of active material layer (g) | Compacted density PD_{A} | Porosity P_{A} | $\frac{{M}_{E} \times {C}_{I}}{\frac{{M}_{A}}{{PD}_{A}} \times {P}_{A}}$ |
| Example 1 | LiFSI | 15.2 | LiPF₆ | 5.2 | 14 | 20% | / | 25 | 1.5 | 30% | 2.0 |
| Example 2 | LiFSI | 22.42 | LiPF₆ | 2.12 | 20 | 20% | / | 24 | 1.65 | 20% | 6.2 |
| Example 3 | LiFSI | 10.5 | LiPF₆ | 8.43 | 14 | 20% | / | 26 | 1.5 | 30% | 1.3 |
| Example 4 | LiFSI | 22.42 | LiPF₆ | 2.12 | 14 | 20% | / | 25 | 1.5 | 45% | 1.7 |
| Example 5 | LiFSI | 5.13 | LiPF₆ | 9.5 | 14 | 20% | / | 24 | 1.45 | 45% | 0.6 |
| Example 6 | LiFSI | 5.11 | LiPF₆ | 9.5 | 20 | 20% | / | 24 | 1.45 | 45% | 0.8 |
| Example 7 | LiFSI | 10.5 | LiPF₆ | 8.43 | 14 | 10% | / | 26 | 1.5 | 30% | 1.3 |
| Example 8 | LiFSI | 10.5 | LiPF₆ | 8.43 | 14 | 10% | Fluoroethylene | 26 | 1.5 | 30% | 1.3 |
| | | | | | | | carbonate | | | | |
| Example 9 | LiFSI | 10.5 | LiPF₆ | 8.43 | 14 | 10% | Lithium | 26 | 1.5 | 30% | 1.3 |
| | | | | | | | difluoroacetate | | | | |
| | | | | | | | borate | | | | |
| Example 10 | LiFSI | 10.3 | LiPF₆ | 8.43 | 14 | 10% | Lithium | 26 | 1.5 | 30% | 1.3 |
| | | | | | | | difluorophosphate | | | | |
| Comparative | / | / | LiPF₆ | 12.9 | 14 | 20% | / | 26 | 1.5 | 30% | 0.0 |
| Example 1 | | | | | | | | | | | |
| Comparative | LiFSI | 22.42 | LiPF₆ | 2.12 | 21 | 20% | / | 24 | 1.65 | 19% | 6.8 |
| Example 2 | | | | | | | | | | | |
| Comparative | LiFSI | 5.18 | LiPF₆ | 9.3 | 13 | 20% | / | 24 | 1.45 | 45% | 0.5 |
| Example 3 | | | | | | | | | | | |

Test Methods:

(1) Cycling performance test of the lithium-ion secondary battery:

Fresh lithium-ion secondary batteries prepared in the examples and comparative examples were set aside for 5 minutes at 45° C., charged at a constant current rate of 1 C to 4.2 V, constant-voltage charged until the current was less than or equal to 0.05 C, after that, set aside for 5 minutes, and then discharged at a constant current rate of 1 C to 2.8 V. This was a charge and discharge cycle, and discharge capacities at this time were recorded as discharge capacities of the first cycle of the lithium-ion secondary batteries. The lithium-ion secondary batteries were charged and discharged for 100 cycles by using the foregoing method, and a discharge capacity of each cycle was recorded.

$$Capacity retention rate ( \% ) of the lithium \text{-} ion secondary battery after 100 cycles under 1 C / 1 C at 45 ° C = ( Discharge capacity of the {100}^{th} cycle / Discharge capacity of the 1 st cycle ) \times 100 \%$$

(2) High-temperature storage test of the lithium-ion secondary battery:

Fresh lithium-ion secondary batteries prepared in the examples and comparative examples were set aside for 5 minutes at 25° C., charged at a constant current rate of 1 C to 4.2 V, constant-voltage charged until the current was less than or equal to 0.05 C, after that, set aside for 5 minutes, and then discharged at a constant current rate of 1 C to 2.8 V. The discharge capacities were recorded as the initial discharge capacities.

The foregoing lithium-ion secondary batteries were set aside again for 5 minutes, charged at a constant current rate of 1 C to 4.2 V, and constant-voltage charged until the current was less than or equal to 0.05 C. The batteries were placed in an oven at 60° C. for one month.

The foregoing lithium-ion secondary batteries were taken out of the oven after the set-aside period. The batteries were cooled to room temperature, set aside for 5 minutes, charged at a constant current rate of 1 C to 4.2 V, constant-voltage charged until the current was less than or equal to 0.05 C, after that, set aside for 5 minutes, and then discharged at a constant current rate of 1 C to 3.0 V. The discharge capacities were recorded as the discharge capacities after storage.

$$Capacity retention rate ( \% ) of the lithium \text{-} ion secondary battery after storage at 60 ° C for one month = ( Discharge capacity after storage / Initial discharge capacity ) \times 100 \% .$$

(3) Thermal shock test of the lithium-ion secondary battery:

Fresh lithium-ion secondary batteries prepared in the examples and comparative examples were set aside for 5 minutes at 25° C., charged at a constant current rate of 1 C to 4.2 V, and constant-voltage charged until the current was less than or equal to 0.05 C.

The foregoing lithium-ion secondary batteries were placed in an oven, and the temperature was risen from 25° C. to 130° C. at a rate of 2° C. per minute, and kept for 2 hours. The surface temperatures of the batteries during this period were monitored.

(4) Floating charge and physical resistance tests of the lithium-ion battery:

Physical resistance of a battery including the positive electrode plate to be screened was tested at 1 kHz and recorded as R1. The battery was charged at a constant current of 1 C to 4.2 V, charged at a constant voltage of 4.2 V until the current was 0.1 C, and continued to be charged at a constant voltage of 4.2 V for 24 hours. Its physical resistance at 1 kHz was tested and recorded as R2.

An increase rate of physical resistance of the lithium-ion battery in floating charge ΔR=(R2−R1)/R1.

Performance test results of the examples and comparative examples were shown in Table 2.

TABLE 2

| | | | Capacity | Capacity |
|---|---|---|---|---|
| | | | retention | retention |
| | Increase | Highest | rate after | rate after |
| | rate of | temperature | 100 cycles | storage for |
| | resistance in | rise in | under 1 C/ | one month |
| | floating | thermal | 1 C at | under 100% |
| | charge | shock test | 45° C. | SOC at |
| No. | (times) | (° C.) | (%) | 60° C. (%) |
| Example 1 | 3.31 | 170.1 | 84.8 | 88.2 |
| Example 2 | 5.32 | 169.7 | 84.1 | 90.2 |
| Example 3 | 2.6 | 173.2 | 85.7 | 87.5 |
| Example 4 | 4.53 | 168.5 | 84.2 | 90.6 |
| Example 5 | 2.43 | 175.2 | 86.5 | 86.9 |
| Example 6 | 2.31 | 176.8 | 86.9 | 86.6 |
| Example 7 | 1.72 | 171.9 | 87.2 | 91.3 |
| Example 8 | 1.21 | 172.1 | 87.5 | 91.8 |
| Example 9 | 1.45 | 172.3 | 87.9 | 91.6 |
| Example 10 | 1.1 | 171.6 | 87.8 | 92.3 |
| Comparative | 0.07 | 285.3 | 87.1 | 81.5 |
| Example 1 | | | | |
| Comparative | 60.1 | 168.8 | 66.7 | 90.1 |
| Example 2 | | | | |
| Comparative | 0.06 | 174.7 | 79.2 | 82.1 |
| Example 3 | | | | |

The test results are analyzed in the following.

It can be learned from Examples 1 to 10 that high safety and excellent cycling performance can be finally achieved by injecting the electrolyte with the fluorine-containing sulfonimide lithium salt as the first lithium salt into the cell, and adjusting the amount of the fluorine-containing sulfonimide lithium salt that can be accommodated per unit volume of pores in the negative electrode plate.

It can be learned from Comparative Example 1 and Comparative Example 3, when no fluorine-containing sulfonimide lithium salt is contained in the electrolyte, or the amount of the fluorine-containing sulfonimide lithium salt that can be accommodated per unit volume of pores in the negative electrode plate is too low, side reactions of the lithium-ion batteries at high temperature or in a high fully charged state are intensified, and gas production and heat production of the batteries increase, thereby deteriorating safety and high-temperature cycling and storage.

It can be learned from Comparative Example 2, when the amount of the fluorine-containing sulfonimide lithium salt that can be accommodated per unit volume of pores in the negative electrode plate is too high, viscosity of the prepared electrolyte is relatively high due to a high density of the fluorine-containing sulfonimide lithium salt itself. This drastically reduces the lithium ion transmission effect, and also accelerates the corrosion of the positive current collector aluminum foil, resulting in that the battery polarization is significantly increased, an increase of resistance in floating charge is too large, and the cycle capacity retention rate of the lithium-ion battery is reduced, which is not conducive to making a battery with excellent cycling performance.

It can be further learned from Examples 7 to 9 that the percentage of the organic solvent, preferably, the cyclic carbonate, contained in the electrolyte does not exceed 10 wt %, so as to reduce gas generation caused by the solvent on a positive electrode surface. When characteristic additives such as fluoroethylene carbonate, lithium difluorophosphate, and lithium difluoroacetate borate are further added, the corrosion resistance of the positive electrode aluminum foil surface and film-forming effect are further improved, a resistivity increase of the lithium-ion battery in floating charge is suppressed, and cycling and gas generation problems are alleviated.

In conclusion, this application effectively overcomes various shortcomings in the prior art and has high industrial utilization value.

The foregoing embodiments only illustrate the principles and effects of this application by using examples, but are not intended to limit this application. Any person familiar with this technology can make modifications or changes to the foregoing embodiments without departing from the spirit and scope of this application. Therefore, all equivalent modifications or changes made by a person of ordinary skill in the technical field without departing from the spirit and technical ideas disclosed in this application shall still fall within the claims of this application.

1. A lithium-ion battery, comprising a positive electrode plate, a negative electrode plate, a separator, and an electrolyte, wherein the negative electrode plate comprises a negative electrode active material layer containing a negative electrode active material, and the electrolyte comprises an electrolyte lithium salt, and wherein
the electrolyte lithium salt comprises a first lithium salt, wherein the first lithium salt is selected from fluorine-containing sulfonimide lithium salts, and
the first lithium salt and the negative electrode plate satisfy the following relation (1):
$$0.6 \leq \frac{{M}_{E} \times {C}_{I}}{\frac{{M}_{A}}{P {D}_{A}} \times {P}_{A}} \leq 6.2 \qquad ( 1 )$$
wherein M_{E} is a total mass of the electrolyte in the lithium-ion battery, measured in g;
C_{I} is a mass percentage of the first lithium salt with respect to the electrolyte, measured in %;
M_{A} is a total mass of the negative electrode active material layer in the lithium-ion battery, measured in g;
PD_{A} is a compacted density of the negative electrode active material layer, measured in g/cm³; and
P_{A} is a porosity of the negative electrode active material layer, measured in %.

2. The lithium-ion battery according to claim 1, wherein the fluorine-containing sulfonimide lithium salt per unit volume of pores in the negative electrode active material layer is 0.6 g/cm³ to 6.2 g/cm³.

3. The lithium-ion battery according to claim 1, wherein the fluorine-containing sulfonimide lithium salt is a lithium salt with a chemical structure formula shown in Formula I: 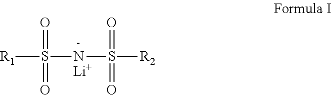
wherein R₁ and R₂ each may be independently selected from a fluorine atom or a fluorinated hydrocarbyl group having 1 to 8 carbon atoms, and at least one of R₁ and R₂ comprises fluorine.

4. The lithium-ion battery according to claim 3, wherein in Formula I, R₁ and R₂ each may be independently selected from —CₐH_{b}F_{c} or —CF₂CF₂(OCF₂CF₂)_{d}F, wherein a is 0, 1, 2, 3, 4, 5, 6, 7 or 8, b and c are integers, b+c=2a+1, and d is 1, 2 or 3.

5. The lithium-ion battery according to claim 1, wherein the fluorine-containing sulfonimide lithium salt is selected from one or more of lithium bis(fluorosulfonyl)imide (LiFSI), lithium fluorosulfonyl (trifluoromethanesulfon)imide, lithium bistrifluoromethanesulfonimide (LiTFSI), lithium methyl trifluoromethanesulfonimide, lithium fluoromethyl (pentafluoroethyl) sulfonimide, and lithium bis(pentafluoroethyl)sulfonimide, and
preferably, the fluorine-containing sulfonimide lithium salt comprises lithium bis(fluorosulfonyl)imide, or the fluorine-containing sulfonimide lithium salt is lithium bis(fluorosulfonyl)imide.

6. The lithium-ion battery according to claim 1, wherein a mass percentage C_{I} of the first lithium salt with respect to the electrolyte is greater than and/or equal to 4.0 wt %, preferably, C_{I}≥5.0 wt %, or more preferably, C_{I}≥5.5 wt %.

7. The lithium-ion battery according to claim 1, wherein the electrolyte lithium salt comprises a second lithium salt, and the second lithium salt is selected from one or more of LiPF₆, LiBF₄, LiSbF₆, LiAsF₆, LiClO₄, and LiB(C₂O₄).

8. The lithium-ion battery according to claim 1, wherein the electrolyte lithium salt comprises a second lithium salt, and the second lithium salt is selected from an inorganic fluorine-containing lithium salt, and preferably, the second lithium salt is selected from one or more of LiPF₆, LiBF₄, LiPO₂F₂, and Li₃POF.

9. The lithium-ion battery according to claim 7, wherein a molar ratio of the first lithium salt to the second lithium salt ranges from 1:1 to 20:1, more preferably, from 1.2:1 to 10:1, and in particular preferably from 6:4 to 9:1.

10. The lithium-ion battery according claim 1, wherein the electrolyte comprises an organic solvent, and the organic solvent is selected from one or more of dimethyl carbonate (DMC), diethyl carbonate (DEC), dipropyl carbonate (DPC), ethyl methyl carbonate (EMC), methyl propyl carbonate (MPC), ethylene propyl carbonate (EPC), vinyl ethylene carbonate (VEC), ethylene carbonate (EC), propylene carbonate (PC), γ-butyrolactone (GBL), butylene carbonate (BC), fluoroethylene carbonate (FEC), methylmethyl formate (MF), ethyl formate, methyl acetate (MA), ethyl acetate (EA), propyl acetate (PA), methyl propionate (MP), ethyl propionate (EP), propyl propionate (PP), methyl butyrate (MB), ethyl butyrate (EB), sulfolane (SF), methyl sulfonyl methane (MSM), methyl ethyl sulfone (EMS), diethyl sulfone (ESE), tetrahydrofuran (THF), and propylene sulfite.

11. The lithium-ion battery according to claim 10, wherein cyclic carbonate contained in the organic solvent is no more than 10 wt %.

12. The lithium-ion battery according to claim 1, wherein the electrolyte further comprises one or more of fluoroethylene carbonate, lithium difluorophosphate, lithium difluoroacetate borate, and lithium difluorobisoxalate phosphate.

13. The lithium-ion battery according to claim 12, wherein a porosity P_{A} of the negative electrode active material layer is 10% to 50%; and/or
a compacted density PD_{A} of the negative electrode active material layer is 1.5 g/cm³ to 2.1 g/cm³; and/or
the negative electrode active material comprises one or more of artificial graphite and natural graphite.

14. The lithium-ion battery according to claim 1, wherein the negative electrode active material further comprises one or more of a mesocarbon microbead (MCMB), hard carbon, soft carbon, silicon, a silicon-carbon composite, SiO, a Li—Sn alloy, a Li—Sn—O alloy, Sn, SnO, SnO₂, spinel-structure lithium titanate Li₄Ti₅O₁₂, a Li—Al alloy, and metal lithium.

15. The lithium-ion battery according to claim 1, wherein an increase rate of physical resistance of the lithium-ion battery in floating charge ΔR≤60:
$$Δ R = ( R 2 - R 1 ) / R 1 \qquad ( 2 )$$
wherein R1 is physical resistance of the lithium-ion battery at 1 kHz; and R2 is physical resistance of the lithium-ion battery at 1 kHz after the lithium-ion battery is charged at a constant current of 1 C to a rated voltage, constant-voltage charged at the rated voltage until the current is 0.1 C, and constant-voltage charged at the rated voltage for 24 hours.

16. A battery module, comprising the lithium-ion battery according to claim 1.

17. A battery pack, comprising the battery module according to claim 16.

18. An apparatus, comprising the lithium-ion battery according to claim 1.

19. The apparatus according to claim 18, wherein the apparatus is selected from one or more of an electric vehicle, an electric vessel, an electric tool, an electronic device, and an energy storage system.
